(19) United States
(12) Patent Application Publication
(10) Pub. No.: US 2008/0224589 A1
(43) Pub. Date: Sep. 18, 2008

(54) Plasma Display Panel

(76) Inventor: Tae-Seung Cho, Suwon-si (KR)

Correspondence Address: CHRISTIE, PARKER & HALE, LLP, PO BOX 7068, PASADENA, CA, 91109-7068, US

(21) Appl. No.: 12/046,301

(22) Filed: Mar. 11, 2008

(30) Foreign Application Priority Data
Mar. 12, 2007 (KR) 10-2007-0024192

(51) Int. Cl. H01J 1/62

(52) U.S. Cl. 313/485; 313/484

(57) ABSTRACT

A plasma display panel (PDP) in which oxide film-coated aluminum wire electrodes are formed between adjacent discharge cells while an image is displayed on front surfaces of the discharge cells. The PDP includes a first substrate and a second substrate spaced apart from the first substrate and facing the first substrate. Barrier ribs are disposed between the first substrate and the second substrate and define a plurality of discharge spaces. Discharge electrodes are arranged between adjacent discharge spaces in order to be exposed to the discharge spaces while an image is displayed on front surfaces of the discharge spaces.

### CROSS-REFERENCE TO RELATED PATENT APPLICATION

This application claims priority to and the benefit of Korean Patent Application No. 10-2007-0024192, filed on Mar. 12, 2007, in the Korean Intellectual Property Office, the entire content of which is incorporated herein by reference.

### BACKGROUND OF THE INVENTION

1. Field of the Invention

The present invention relates to a plasma display panel (PDP), and, more particularly, to a PDP having electrodes on sidewalls of discharge cells for displaying an image.

2. Description of the Related Art

PDPs, which are being used as a replacement for conventional cathode ray tubes (CRTs), are display devices that display images by applying a discharge voltage to a plurality of electrodes formed on the substrates in order to generate ultraviolet (UV) rays that excite phosphor layers arranged in a predetermined pattern.

Conventional alternating current (AC) PDPs include an upper plate that displays an image to users, and a lower plate that is coupled with and is parallel to the upper plate. The front substrate of the upper plate includes sustain electrode pairs arranged thereon. The rear substrate of the lower plate includes address electrodes arranged on a surface facing the surface of the front substrate on which the sustain electrode pairs are arranged. Thus, the direction of the address electrodes intersect the direction of the sustain electrode pairs.

A first dielectric layer and a second dielectric layer are respectively formed on the surface of the front substrate on which the sustain electrode pairs are arranged, and on the surface of the rear substrate on which the address electrodes are arranged, so that the sustain electrode pairs and the address electrodes are buried. A protective layer, conventionally formed of MgO, is arranged on a rear surface of the first dielectric layer. Barrier ribs, for maintaining a discharge distance between the opposing substrates and preventing optical cross-talk between discharge cells, are arranged on the front surface of the second dielectric layer.

Red, green, and blue phosphors are appropriately coated on sidewalls of the barrier ribs and on the front surface of the second dielectric layer.

Each of the sustain electrode pairs includes a transparent electrode and a bus electrode. The transparent electrode is formed of a conductive material capable of generating a discharge and is transparent so as to allow light emitted from the phosphors to propagate toward the front substrate. The transparent material may be indium tin oxide (ITO) or the like. The bus electrode may conventionally be a metal electrode having a high electric conductivity, and is black-colored so as to improve a bright room contrast of the PDPs.

In conventional surface-type PDPs, visible light is emitted from phosphor layers of discharge spaces and transmits through an upper substrate when a discharge occurs. However, the upper substrate has a visible transmittance of about 60% due to various constituents formed thereon.

Furthermore, in conventional surface-type PDPs, electrodes are formed on upper sides of discharge spaces, i.e., inner sidewalls of the upper substrate through which the visible light transmits, and these electrodes generate the discharge in the inner sidewalls, which reduces luminous efficiency of the conventional surface-type PDPs.

### SUMMARY OF THE INVENTION

In accordance with the present invention a PDP is provided where oxide film-coated aluminum wire electrodes are formed on sidewalls of discharge cells and an image is displayed on front surfaces of the discharge cells. As such, the process of forming a dielectric layer is not needed, resulting in an easier manufacturing of the PDP.

According to an embodiment of the present invention, there is provided a plasma display panel comprising: a front (first) substrate; a rear (second) substrate spaced apart from the front substrate and facing the front substrate. Barrier ribs are disposed between the front substrate and the rear substrate and define a plurality of discharge spaces. Discharge electrodes are arranged between adjacent discharge spaces so as to be exposed to the discharge spaces.

The discharge electrodes may include electrode wires and dielectric film coating the electrode wires. For example, the discharge electrodes may include aluminum wires coated with an oxide film.

The electrode wires may be formed of aluminum (Al) and the dielectric film is formed of alumina (Al₂O₃).

The discharge spaces are separated by the discharge electrodes into pairs of discharge space portions.

The barrier ribs may include front (first) barrier ribs formed on the front substrate facing the rear substrate and rear (second) barrier ribs formed on the rear substrate facing the front substrate.

The discharge electrodes may extend in a direction across the discharge cells, and the front barrier ribs and the rear barrier ribs may include horizontal barrier ribs arranged parallel to the discharge electrodes and vertical barrier ribs arranged across the discharge electrodes, wherein the discharge electrodes are disposed between the horizontal barrier ribs of the front barrier ribs and the horizontal barrier ribs of the rear barrier ribs.

According to another embodiment of the present invention, there is provided a PDP wherein discharge electrodes are arranged along sidewalls of a plurality of discharge spaces so as to partially partition the discharge spaces disposed between a pair of substrates facing each other. Each of the discharge electrodes include electrode wires with dielectric film coating the electrode wires.

### BRIEF DESCRIPTION OF THE DRAWINGS

FIG. 1 is a partially exploded perspective view of a PDP where electrodes are disposed in sidewalls of discharge cells, i.e. electrodes are buried in a front barrier ribs structure while an image is displayed on front surfaces of discharge cells.

FIG. 2 is a partially exploded perspective view of a PDP according to an embodiment of the present invention.

FIG. 3 schematically illustrates arrangements of discharge electrodes and discharge spaces of the PDP illustrated in FIG. 2, according to an embodiment of the present invention.

FIG. 4 is a cross-sectional view taken along the line IV-IV of FIG. 3, according to an embodiment of the present invention.

FIG. 5 is a cross-sectional view taken along the line V-V of FIG. 3, according to an embodiment of the present invention.

FIG. 6 is a partially exploded perspective view of a PDP according to another embodiment of the present invention.

FIG. 7 is a cross-sectional view taken along the line VII-VII of FIG. 6, according to an embodiment of the present invention.

### DETAILED DESCRIPTION OF THE INVENTION

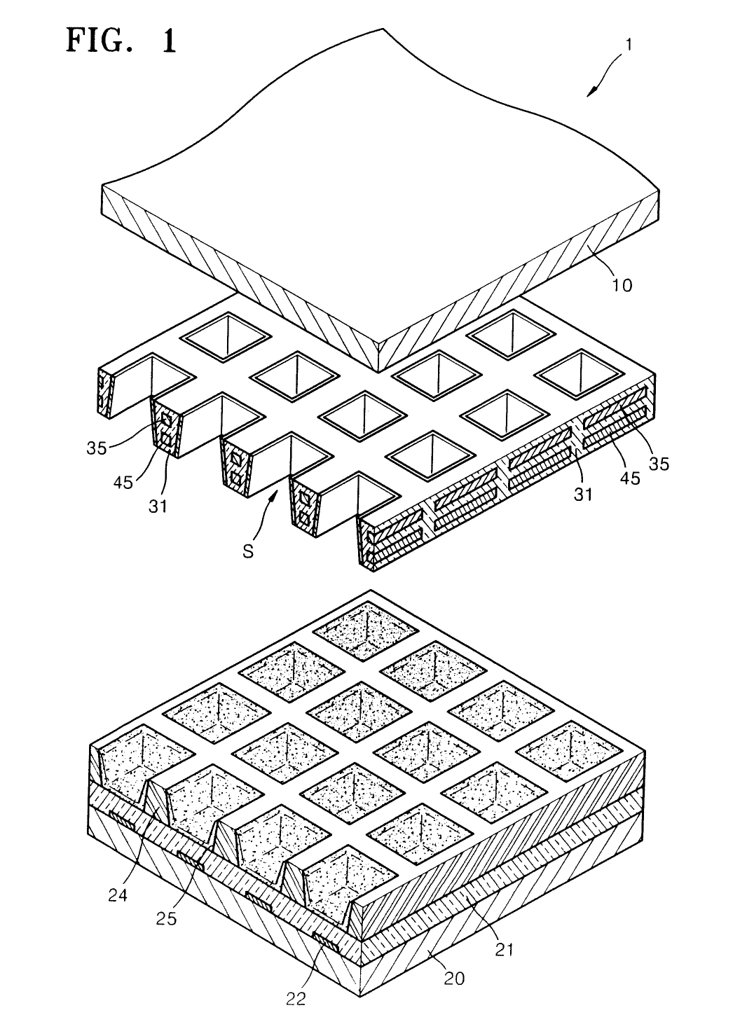

Referring to FIG. 1 one approach to a PDP is shown. A plurality of first discharge electrodes 35 and second discharge electrodes 45 are disposed on sidewalls of discharge cells, i.e. the first discharge electrodes 35 and second discharge electrodes 45 are buried in a front barrier ribs structure 31 while an image is displayed on front surfaces of discharge cells. The PDP 1 includes a front substrate 10 and a rear substrate 20, which are spaced a predetermined distance apart from each other and face each other, and the front barrier ribs structure 31 and a rear barrier ribs structure 24, which are above and below each other and disposed between the front substrate 10 and the rear substrate 20 so as to partition discharge spaces S. The first discharge electrodes 35 and second discharge electrodes 45, which are spaced apart above and below each other, are buried in the front barrier ribs structure 31 in order to generate a display discharge in the discharge spaces S.

The front barrier ribs structure 31 is formed of a dielectric substance in which the first discharge electrodes 35 and second discharge electrodes 45 are buried in order to prevent the first discharge electrodes 35 and second discharge electrodes 45 from being damaged due to collisions between ions and to provide an environment favorable for discharge. Phosphor layers 25 are disposed in areas partitioned by the rear barrier ribs structure 24.

A plurality of address electrodes 22, extending to cross the first discharge electrodes 35 and second discharge electrodes 45, and a dielectric layer 21, that bury the address electrodes 22, are disposed on the rear substrate 20.

In the PDP 1, the discharge is generated through all the side walls of the front barrier ribs structure 31 partitioning the discharge spaces S, so that the phosphor layers 25 disposed on the rear substrate 20 do not easily deteriorate due to collisions between ions. Opaque electrode elements are removed from the front substrate 10 so that the upward transmittance of visible light increases. The discharge is generated through all the side walls of the front barrier ribs structure 31 partitioning the discharge spaces S and plasma concentrates in the center of the discharge spaces S, so that the amount of ultraviolet rays dramatically increases.

However, the PDP 1 cannot be easily mass produced when the first discharge electrodes 35 and second discharge electrodes 45 are buried in the front barrier ribs structure 31.

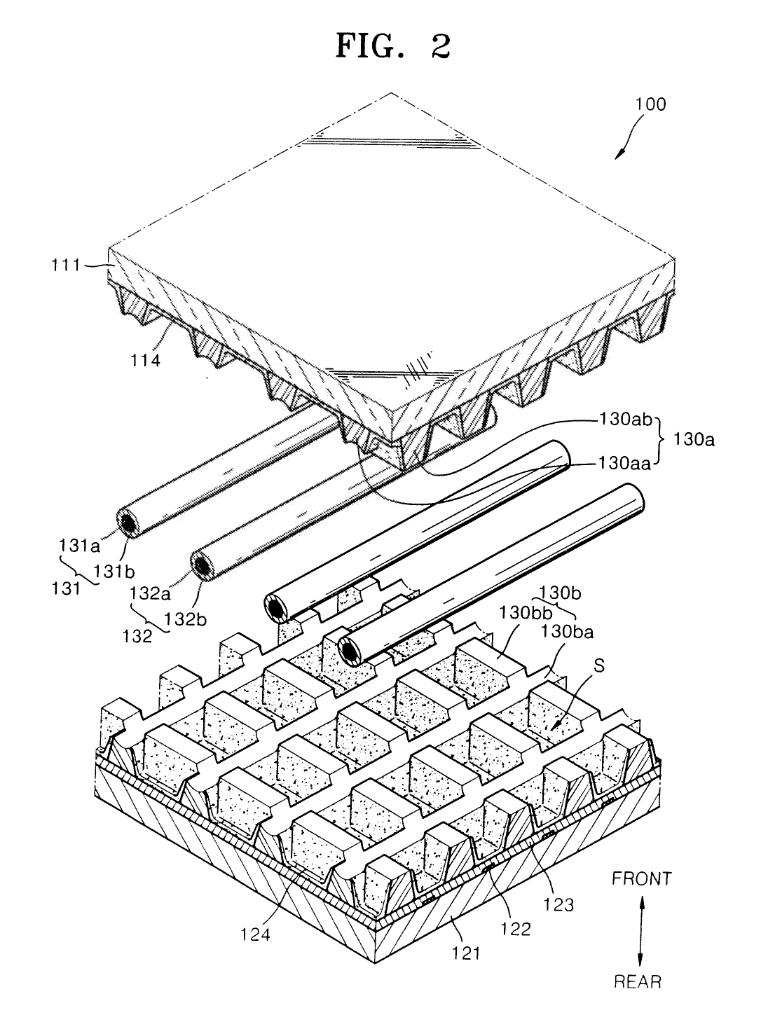

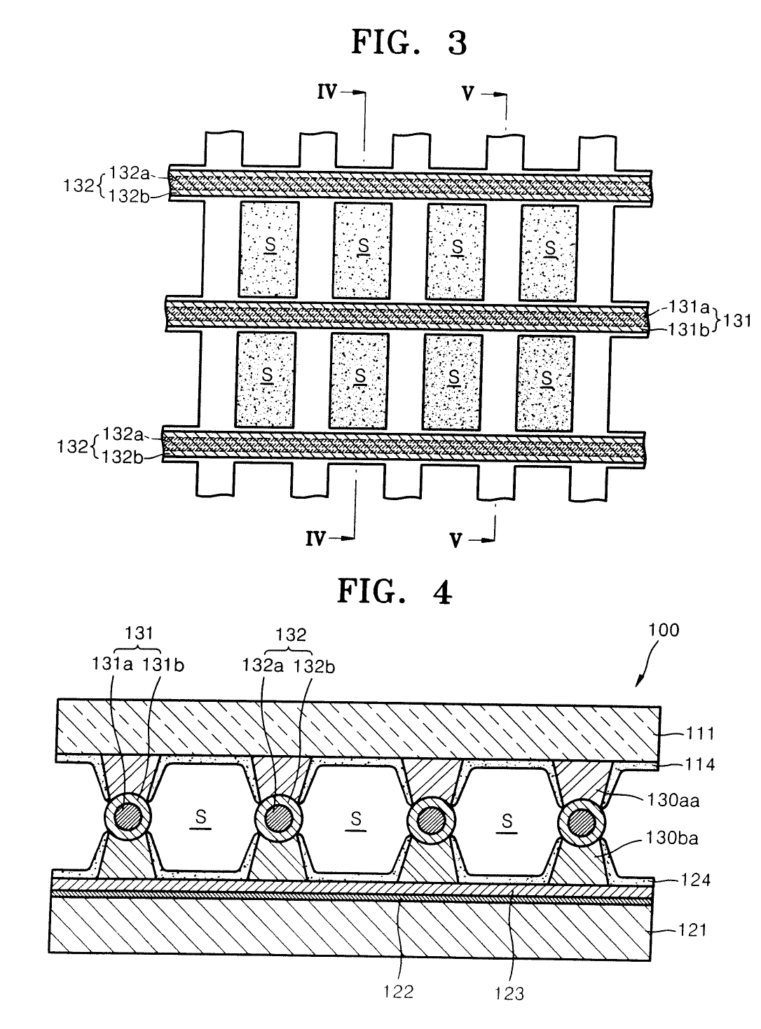

Referring now to FIGS. 2 through 5, the PDP 100 includes a front substrate 111, a rear substrate 121, barrier ribs 130a, 130b, address electrodes 122, a dielectric layer 123, front phosphor layers 114, rear phosphor layers 124, and discharge electrodes 131, 132.

The front substrate 111 and the rear substrate 121 are spaced apart from each other and face each other. The barrier ribs 130a, 130b are disposed between the front substrate 111 and the rear substrate 121 and partition the discharge spaces S. The discharge electrodes 131, 132 are respectively arranged along the sidewalls of the discharge spaces S and are exposed to the discharge spaces S while an image is displayed on front surfaces of the discharge spaces S. Each of the pairs of discharge electrodes 131, 132 includes an X electrode 131 and a Y electrode 132, which are alternately arranged to generate a mutual sustain discharge.

The discharge electrodes 131, 132 extend in a direction across the discharge spaces S. In more detail, referring to FIG. 4, the discharge electrodes 131, 132 are exposed to the sidewalls of each of the adjacent discharge spaces S so as to partially partition the adjacent discharge spaces S.

Each of the discharge electrodes 131, 132 includes electrode wires 131a, 132a and oxide film 131b, 132b coating the electrode wires 131a, 132a, respectively. The electrode wires 131a, 132a can be formed of aluminum (Al) and the oxide film 131b, 132b can be formed of alumina (Al₂O₃). Hence, each of the discharge electrodes 131, 132 can be aluminum wires coated with oxide film formed of alumina. However, the present invention is not limited thereto and the electrode wires 131a, 132a can be formed of other substances such as silver (Ag) having excellent electrical conductivity.

The oxide film 131b, 132b are formed on outer surfaces of the electrode wires 131a, 132a to a predetermined thickness by an oxide process such as anodizing. The electrode wires 131a, 132a, coated by the oxide film 131b, 132b, remain as core portions, which are not oxidized and maintain their electrically conductivity. The electrode wires 131a, 132a are electrically insulated from the outside by the oxide film 131b, 132b.

For example, the oxide film 131b, 132b may be formed of insulating alumina when aluminium is used in forming the electrode wires 131a, 132a. The oxide film 131b, 132b, formed on the surface in contact with the discharge spaces S, function as a conventional dielectric layer by preventing direct connection of the electrode wires 131a, 132a and damage to the electrode wires 131a, 132a caused by collisions with charged particles participating in the discharge.

The oxide film 131b, 132b may be formed to a sufficient thickness taking into consideration withstanding voltage characteristics in order to protect the electrode wires 131a, 132a. The thickness of the oxide film 131b, 132b may be optimized by controlling the process conditions, such as an applied current, a selection of electrolytic solution, and process time if an oxidation process is performed.

The discharge electrode may have rounded tetragonal cross-sectional shapes. In this regard, the edges of the electrode wires 131a, 132a may be rounded, and the edges of the oxide film 131b, 132b in contact with the discharge spaces S may be rounded.

Due to characteristics of an anodizing process in which oxidation is performed on an exposed surface of the electrode wires 131a, 132a, it is difficult to form an oxide with a compact texture on sharp cutting edges.

Therefore, the corner portions of the oxide film 131b, 132b are rounded in order to remove sharp cutting edges of the corner portions thereof, so that edges of the corner portions prevent the deterioration of the electrode wires 131a, 132a in the oxide film 131b, 132b, and the electrode wires 131a, 132a are entirely coated with the oxide film 131b, 132b having a constant thickness.

Unlike the PDP 1 shown in FIG. 1, the PDP 100 of the present embodiment does not include the discharge electrodes 131, 132 buried in the barrier ribs 130. Therefore, the discharge electrodes 131, 132 of the PDP 100 partition the discharge spaces S, and thereby, the forming of the discharge electrodes 131, 132 and the barrier ribs 130 is easily accomplished.

In the PDP 100, the discharge electrodes 131, 132 are disposed between adjacent discharge spaces S. Thus, the discharge electrodes 131, 132 do not cross the front substrate 111 or the rear substrate 121 through which the visible light transmits, and thereby, increase the transmittance of the visible light and the luminous efficiency of the PDP 100.

Furthermore, voltages are applied to the discharge electrodes 131, 132 thereby generating the discharge through the sidewalls of the discharge spaces S, so that the discharge spreads relatively uniformly in the discharge spaces S, and thereby increases the brightness and luminous efficiency of the PDP 100.

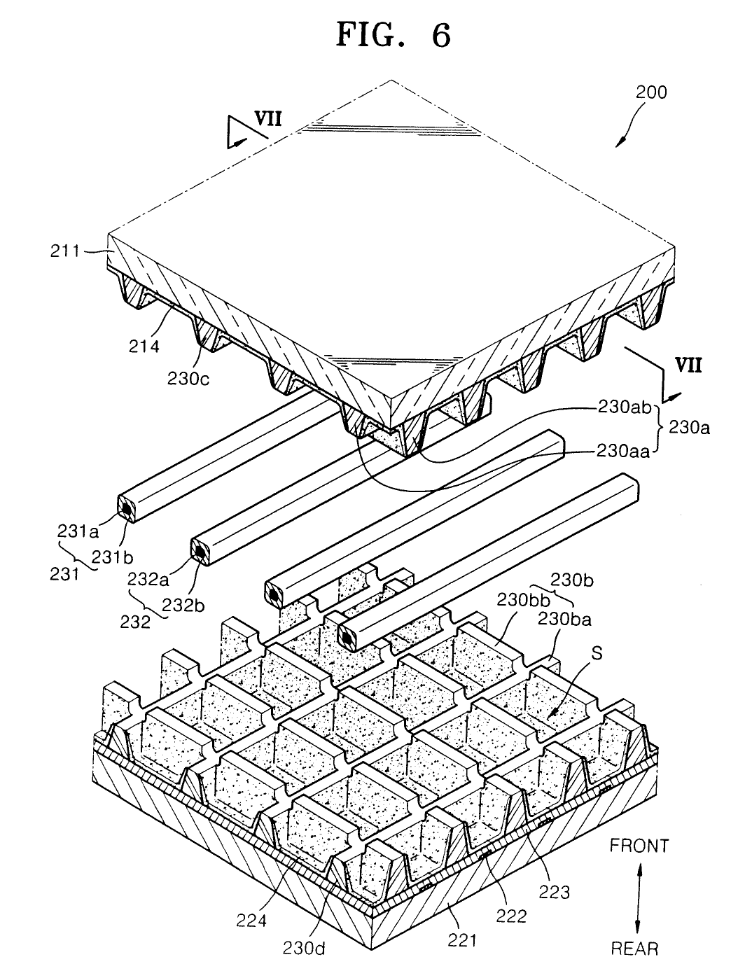

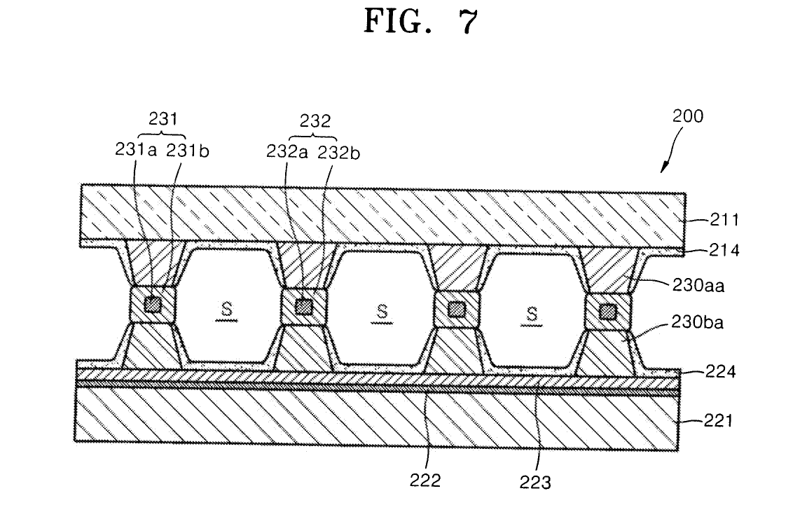

The discharge electrodes 131, 132 are depicted as having circular cross-sections. However, the present invention is not limited thereto, and the discharge electrodes 131, 132 can have a variety of cross-sectional shapes such as oval cross-sections, or rounded tetragonal cross-sections as illustrated in FIGS. 6 and 7.

The discharge electrodes 131, 132 can include X electrodes and Y electrodes, which are alternately arranged to generate a mutual sustain discharge. The address electrodes 122 are disposed to cross the discharge electrodes 131, 132 and generate an address discharge between the address electrodes 122 and Y electrodes 132. The address electrodes 122 can be perpendicular to the discharge electrodes 131, 132, so that each of the discharge spaces S can be a coordinate defined in terms of where each of the address electrodes 122 and each of the discharge electrodes 131, 132 cross each other.

The barrier ribs 130 include front barrier ribs 130a and rear barrier ribs 130b. The front barrier ribs 130a are formed on the front substrate 111 facing the rear substrate 121. The rear barrier ribs 130b are formed on the rear substrate 121 facing the front substrate 111. The discharge electrodes 131, 132 can be disposed between the front barrier ribs 130a and rear barrier ribs 130b.

The front barrier ribs 130a and rear barrier ribs 130b also include horizontal barrier ribs 130aa, 130ba and vertical barrier ribs 130ab, 130bb, respectively. The horizontal barrier ribs 130aa, 130ba are disposed in parallel to the discharge electrodes 131, 132. The vertical barrier ribs 130ab, 130bb are disposed perpendicular to the discharge electrodes 131, 132.

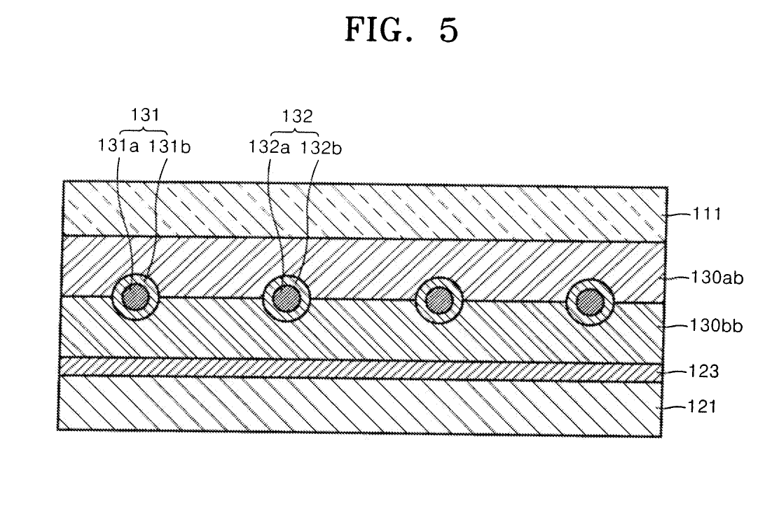

The front barrier ribs 130a and rear barrier ribs 130b define the discharge spaces S, prevent cross-talk between the discharge spaces S, and serve as supports and passages on which the discharge electrodes 131, 132 are not twisted but, extend straight. Referring to FIG. 5, the vertical barrier ribs 130ab, 130bb are formed to be taller than the horizontal barrier ribs 130aa, 130ba by the height of the discharge electrodes 131, 132 in the front barrier ribs 130a and rear barrier ribs 130b.

The dielectric layer 123 is disposed on the rear substrate 121 to cover the address electrodes 122 in order to protect the address electrodes 122. The front phosphor layers 114 are disposed on the sidewalls of the front barrier ribs 130a of the discharge spaces S and the lower surface of the front substrate 111. The second phosphor layers 124 is disposed on the sidewalls of the rear barrier ribs 130b of the discharge spaces S and the upper surface of the dielectric layer 123.

In the PDP 100 of the present embodiment both the front phosphor layers 114 and the rear phosphor layers 124 are formed. However, the present invention is not limited thereto. Thus, only one of the first phosphor layers 114 and the second phosphor layers 124 may be formed.

The front substrate 111 and the rear substrate 121 are spaced apart from each other by a predetermined gap and partition the discharge spaces S where the discharge is generated therebetween. The front substrate 111 and the rear substrate 121 may be formed of glass having a high visible transmittance. However, at least one of the front substrate 111 and the rear substrate 121 can be colored to improve a bright room contrast of the PDP 100.

The barrier ribs 130a, 130b are disposed on the front substrate 111 and the on rear substrate 121 respectively, or can be disposed solely on the dielectric layer 123 according to a manufacturing process. The barrier ribs 130a, 130b define the discharge spaces S and prevent optical and electrical cross-talk between the discharge spaces S.

In the present embodiment, the barrier ribs 130a, 130b define the discharge spaces S having tetragonal cross-sections, however, the present invention is not limited thereto. Thus, the barrier ribs 130a, 130b can define the discharge spaces S having polygonal cross-sections, such as triangular or pentagonal cross-sections, or circular or oval cross-sections, or open-type cross-sections such as stripes. The discharge spaces S of the barrier ribs 130a, 130b can have a delta configuration.

From among the discharge electrodes 131, 132, the X electrodes serve as common electrodes and the Y electrodes serve as scan electrodes. The X electrodes and the Y electrodes are alternately arranged with respect to each discharge line, so that the PDP 100 of the present embodiment can be driven by alternately scanning an even electrode group and an odd electrode group. Furthermore, a PDP according to the present invention may not only have a three-electrode structure as shown in the present embodiment, however, may also have a two-electrode structure in which the discharge electrodes 131, 132 are a group of electrodes.

The address electrodes 122 generate the address discharge that facilitates a sustain discharge between the X electrodes and the Y electrodes. More specifically, the address electrodes 122 produce a voltage for generating the sustain discharge. The address discharges are generated between the Y electrodes and the address electrodes 122. When the address discharge is completed, wall charges accumulate on the X electrodes and the Y electrodes, which facilitates the sustain discharge between the X electrodes and the Y electrodes.

Each pair of the X electrodes and the Y electrodes and each of the address electrodes 122 across the X electrodes and the Y electrodes form a unit discharge cell.

The dielectric layer 123 is formed on the rear substrate 121 in order to bury the address electrodes 122. The dielectric layer 123 is formed of a dielectric substance to prevent the address electrodes 122 from being damaged due to collisions between charge particles or electrons and the address electrodes 122, and to induce charges. The dielectric substance may be PbO, B₂O₃, SiO₂ or the like.

The rear phosphor layers 124 having respective red, green, and blue phosphors are arranged on sidewalls of the barrier ribs 130 and on the front surface of the dielectric layer 123. The first and second phosphor layers 114, 124 have a component generating visible rays due to ultraviolet rays. Hence, a phosphor layer. formed in a red light-emitting discharge cell, has a phosphor such as Y(V,P)O₄:Eu, a phosphor layer, formed in a green light-emitting discharge cell, has a phosphor such as Zn₂SiO₄:Mn, YBO₃:Tb, and a phosphor layer, formed in a blue light-emitting discharge cell, has a phosphor such as BAM:Eu.

A discharge gas, such as Ne, Xe, or a mixture thereof, is fills the discharge cells. When the discharge cells are filled with the discharge gas, the front substrate 111 and the rear substrate 121 are coupled to each other by a sealing member such as frit glass formed along the edges of the front substrate 111 and the rear substrate 121.

The discharge gas is excited as a result of the sustain discharge. The energy level of the discharge gas drops, and ultraviolet rays are generated. The ultraviolet rays excite the first and second phosphor layers 114, 124 disposed on the discharge spaces S, drop the energy level of the first and second phosphor layers 114, 124, and are changed into visible rays that a user can perceive. The visible rays are transmitted through the front substrate 111 so that a image can be displayed.

FIG. 6 is a partially exploded perspective view of a PDP 200 according to another embodiment of the present invention. FIG. 7 is a cross-sectional view taken along the line VII-VII of FIG. 6, according to an embodiment of the present invention.

Referring to FIGS. 6 and 7, the PDP 200 includes a front substrate 211, a rear substrate 221, barrier ribs 230a, 230b, address electrodes 222, a dielectric layer 223, front phosphor layers 214, rear phosphor layers 224, and discharge electrodes 231, 232.

The discharge electrodes 231, 232 are arranged along sidewalls of a plurality of discharge spaces S while an image is displayed on front surfaces of the discharge spaces S so as to partition the discharge spaces S disposed between the front substrate 211 and the rear substrate 221 that face each other. Each of the discharge electrodes 231, 232 include electrode wires 231a, 232a and dielectric film 231b, 232b coating the electrode wires 231a, 232a, respectively.

The discharge electrodes 231, 232 partition the adjacent discharge spaces S. In more detail, referring to FIG. 6, the discharge electrodes 231, 232 are exposed to the sidewalls of each of the adjacent discharge spaces S so as to partially partition the adjacent discharge spaces S.

The electrode wires 231a, 232a are formed of aluminum and the dielectric film 231b, 232b are formed of alumina. Hence, the discharge electrodes 231, 232 can be aluminum wires coated with oxide film formed of alumina. However, the present invention is not limited thereto and the electrode wires 231a, 232a can be formed of other substances such as silver having excellent electrical conductivity.

The only difference in the PDP 200 of FIG. 6 from the PDP 100 of FIG. 2 is that the discharge electrodes 231, 232 have tetragonal cross-sectional shapes. In FIGS. 6 and 7, like reference numerals denote like elements having the same function, and thus, the detailed descriptions thereof will not be repeated.

According to a PDP of the present invention, oxide film-coated aluminum wire electrodes are formed between adjacent discharge cells in one direction while an image is displayed on front surfaces of discharge cells. This structure does not require the conventional process of forming a dielectric layer, and thereby, easily manufacturing the PDP.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A plasma display panel comprising:
a first substrate;
a second substrate spaced apart from and facing the first substrate;
barrier ribs between the first substrate and the second substrate defining a plurality of discharge spaces; and
discharge electrodes between adjacent discharge spaces and exposed to the discharge spaces.

2. The plasma display panel of claim 1, wherein the discharge electrodes comprise aluminum wires coated with oxide film.

3. The plasma display panel of claim 1, wherein the discharge electrodes comprise electrode wires coated with dielectric film.

4. The plasma display panel of claim 1, wherein the electrode wires are aluminum and the dielectric film is alumina.

5. The plasma display panel of claim 1, wherein the discharge spaces are separated by the discharge electrodes into pairs of discharge space portions.

6. The plasma display panel of claim 1, further comprising address electrodes crossing the discharge electrodes.

7. The plasma display panel of claim 1, wherein the barrier ribs comprise first barrier ribs on the first substrate facing the second substrate and second barrier ribs on the second substrate facing the first substrate.

8. The plasma display panel of claim 7, wherein the discharge electrodes are between the first barrier ribs and the second barrier ribs.

9. The plasma display panel of claim 7,
wherein the discharge electrodes extend in a direction across the discharge spaces, and the first barrier ribs and the second barrier ribs comprise horizontal barrier ribs parallel to the discharge electrodes and vertical barrier ribs across the discharge electrodes,
wherein the discharge electrodes are between the horizontal barrier ribs of the first barrier ribs and the horizontal barrier ribs of the second barrier ribs.

10. The plasma display panel of claim 6, further comprising a dielectric layer on the second substrate covering the address electrodes.

11. The plasma display panel of claim 10, further comprising:
a first phosphor layer on each of the sidewalls of the discharge spaces of the first barrier ribs and on a surface of the first substrate facing the discharge spaces; and
a second phosphor layer on each of the sidewalls of second barrier ribs in the discharge spaces and on a surface of the dielectric layer facing the discharge spaces.

12. A plasma display panel comprising discharge electrodes along sidewalls of a plurality of discharge spaces to partially partition discharge spaces between a pair of substrates facing each other,
wherein each of the discharge electrodes comprise electrode wires having a dielectric film coating the electrode wires.

13. The plasma display panel of claim 12, further comprising barrier ribs between the pair of substrates defining the discharge spaces.

14. The plasma display panel of claim 13,
wherein the pair of substrates comprise a first substrate and a second substrate, and
wherein the barrier ribs comprise first barrier ribs on the first substrate facing the second substrate and second barrier ribs on the second substrate facing the first substrate.

15. The plasma display panel of claim 14,
wherein the first barrier ribs and the second barrier ribs each comprise horizontal barrier ribs parallel to the discharge electrodes and vertical barrier ribs across the discharge electrodes, and
wherein the discharge electrodes extend in a direction across the discharge cells.

16. The plasma display panel of claim 15, wherein the discharge electrodes are between the horizontal barrier ribs of the first barrier ribs and the horizontal barrier ribs of the second barrier ribs.

17. The plasma display panel of claim 14, further comprising a first phosphor layer on the sidewalls of each of the first barrier ribs in the discharge spaces and on a surface of the first substrate facing the discharge spaces.

18. The plasma display panel of claim 14, further comprising address electrodes crossing the discharge electrodes.

19. The plasma display panel of claim 18, further comprising a dielectric layer on the second substrate covering the address electrodes.

20. The plasma display panel of claim 19, further comprising a second phosphor layer on each of the sidewalls of the second barrier ribs in the discharge spaces and on a surface of the dielectric layer facing the discharge spaces.

21. The plasma display panel of claim 12, wherein the electrode wires are aluminum and the dielectric film is alumina.
